(19) United States
(12) Patent Application Publication
(10) Pub. No.: US 2026/0359883 A1
(43) Pub. Date: Nov. 12, 2026

(54) DYNAMIC GALLERIES FOR PRODUCT PAGES AND WEBSITES

(71) Applicant: JBF Interlude 2009 LTD, Tel Aviv (IL)

(72) Inventors: Jonathan Bloch, Ramat HaSharon (IL); Tal Zubalsky, Brooklyn, NY (US); Yuval Hofshy, Kfar Saba (IL); Alon Benari, Brooklyn, NY (US)

(21) Appl. No.: 19/201,324

(22) Filed: May 7, 2025

(51) Int. Cl. G06Q 30/0601; G06F 16/955

(52) U.S. Cl. CPC G06Q 30/0641; G06F 16/955; G06Q 30/0623

(57) ABSTRACT

A method for dynamically presenting a product detail page (PDP), including detecting a user has navigated to a PDP for a product on a first website, obtaining user information associated with the user, wherein the user information includes a navigation process experienced by the user in navigating to the PDP, obtaining device information associated with a user device used by the user to navigate to the PDP, generating a user-specific gallery structure corresponding to the product based on the user information and the device information, configuring the PDP using the user-specific gallery structure, and presenting the PDP to the user via the first website.

### TECHNICAL FIELD

The following disclosure is directed to systems and methods for generating dynamic content for product pages and websites and, more specifically, for generating real-time, dynamic product detail pages (PDPs).

### BACKGROUND

A product detail page (PDP) is a crucial component of any e-commerce website, serving as the central hub for information on a specific product. The PDP may include product details such as size, color, price, and shipping information, as well as customer reviews and other relevant data that potential buyers need to make informed purchase decisions. The effectiveness of a PDP can significantly influence the consumer's buying process, as it provides a comprehensive overview of the product, often supplemented with text, images, and videos. A well-designed PDP not only conveys product features and benefits but also enhances the user experience, which can lead to higher conversion rates and foster customer trust in the brand or product. However, PDPs for specific products are typically fixed. In most cases, the seller (or website operator) uploads content assets (e.g., text, images, video, etc.) that are included in the PDP. This means that each buyer receives the same experience when viewing or interacting with the PDP for a particular product. The PDP will remain in the same fixed state until the seller uploads new content assets to be included in the PDP. While the fixed state of the PDP may appeal to the preferences of some buyers, many buyers may find the PDP to be less than optimal. In some cases, this mismatch between individual buyer preferences and the PDP experience can lead to lower product conversion rates.

### SUMMARY

In various examples, the subject matter of this disclosure relates generating dynamic content for product pages and websites and, more specifically, for generating real-time, dynamic product detail pages (PDPs).

At least one aspect of the present disclosure is directed to a method for dynamically presenting a product detail page (PDP). The method includes detecting a user has navigated to a PDP for a product on a first website, obtaining user information associated with the user, wherein the user information includes a navigation process experienced by the user in navigating to the PDP, obtaining device information associated with a user device used by the user to navigate to the PDP, generating a user-specific gallery structure corresponding to the product based on the user information and the device information, configuring the PDP using the user-specific gallery structure, and presenting the PDP to the user via the first website.

In some embodiments, the user information includes at least one website Uniform Resource Locator (URL) associated with the user. In some embodiments, the at least one website URL corresponds to at least one second website visited by the user prior to navigating to the first website. In some embodiments, the at least one website URL corresponds to a second website that referred the user to the first website. In some embodiments, the user information includes a search string associated with the user, a product campaign associated with the user, at least one behavioral characteristic of the user, an amount of time spent on the website by the user, an amount of time since the user last visited the website, or any combination thereof. In some embodiments, the device information includes a location of the user device, an internet connection speed, a device type, or any combination thereof.

In some embodiments, the method includes generating a configuration file based on the user information and the device information, wherein generating the user-specific gallery structure corresponding to the product based on the user information and the device information includes generating the user-specific gallery structure based on the configuration file. In some embodiments, the method includes obtaining variant information associated with the PDP, wherein the variant information includes two or more variants of the PDP and generating a configuration file based on the user information, the device information, and the variant information, wherein generating the user-specific gallery structure corresponding to the product based on the user information and the device information includes generating the user-specific gallery structure based on the configuration file. In some embodiments, the method includes obtaining test information associated with the PDP, wherein the test information includes two or more test groups that the user may be assigned to in relation to the PDP and generating a configuration file based on the user information, the device information, and the test information, wherein generating the user-specific gallery structure corresponding to the product based on the user information and the device information includes generating the user-specific gallery structure based on the configuration file.

In some embodiments, generating the user-specific gallery structure corresponding to the product based on the user information and the device information includes analyzing the user information and the device information, selecting a gallery structure template from a plurality of gallery structure templates corresponding to the product based on at least one result of the analysis, and populating the gallery structure template with at least one content asset based on the user information and/or the device information. In some embodiments, generating the user-specific gallery structure corresponding to the product based on the user information and the device information includes analyzing the user information and the device information, selecting a predefined gallery structure from a plurality of predefined gallery structures corresponding to the product based on at least one result of the analysis, and modifying at least one content asset of the predefined gallery structure based on the user information and/or the device information.

In some embodiments, the method includes obtaining website information associated with prior user experiences with the website and modifying the user-specific gallery structure based on the website information. In some embodiments, the website information includes an average time spent on the PDP by website visitors, an engagement rate with the PDP by website visitors, a purchase conversion rate associated with the product, an average order rate of the product, or any combination thereof.

In some embodiments, the method includes generating a user-specific content gallery based on the user-specific gallery structure. In some embodiments, the user-specific content gallery includes image content, non-interactive video content, interactive video content, or any combination thereof. In some embodiments, configuring the PDP using the user-specific gallery structure includes selecting at least one content asset of the user-specific content gallery to be displayed on the PDP. In some embodiments, configuring the PDP using the user-specific gallery structure includes analyzing the user information and the device information and determining an order in which content assets of the user-specific content gallery are presented on the PDP based on at least one result of the analysis. In some embodiments, the method includes detecting a change to the device information while the user is viewing the PDP and modifying the PDP in real-time based on the detected change. In some embodiments, modifying the PDP includes selecting a different content asset of the user-specific content gallery to be displayed on the PDP.

Another aspect of the present disclosure is directed to a system for generating a dynamic product detail page (PDP). The system includes at least one memory for storing computer-executable instructions and at least one processor for executing the instructions stored on the at least one memory. Execution of the instructions programs the at least one processor to perform operations that include detecting a user has navigated to a PDP for a product on a first website, obtaining user information associated with the user, wherein the user information includes a navigation process experienced by the user in navigating to the PDP, obtaining device information associated with a user device used by the user to navigate to the PDP, generating a user-specific gallery structure corresponding to the product based on the user information and the device information, configuring the PDP using the user-specific gallery structure, and presenting the PDP to the user via the first website.

In some embodiments, the user information includes at least one website Uniform Resource Locator (URL) associated with the user. In some embodiments, the at least one website URL corresponds to at least one second website visited by the user prior to navigating to the first website. In some embodiments, the at least one website URL corresponds to a second website that referred the user to the first website. In some embodiments, the user information includes a search string associated with the user, a product campaign associated with the user, at least one behavioral characteristic of the user, an amount of time spent on the website by the user, an amount of time since the user last visited the website, or any combination thereof. In some embodiments, the device information includes a location of the user device, an internet connection speed, a device type, or any combination thereof.

In some embodiments, the operations include generating a configuration file based on the user information and the device information, wherein generating the user-specific gallery structure corresponding to the product based on the user information and the device information includes generating the user-specific gallery structure based on the configuration file. In some embodiments, the operations include obtaining variant information associated with the PDP, wherein the variant information includes two or more variants of the PDP and generating a configuration file based on the user information, the device information, and the variant information, wherein generating the user-specific gallery structure corresponding to the product based on the user information and the device information includes generating the user-specific gallery structure based on the configuration file. In some embodiments, the operations include obtaining test information associated with the PDP, wherein the test information includes two or more test groups that the user may be assigned to in relation to the PDP and generating a configuration file based on the user information, the device information, and the test information, wherein generating the user-specific gallery structure corresponding to the product based on the user information and the device information includes generating the user-specific gallery structure based on the configuration file.

In some embodiments, generating the user-specific gallery structure corresponding to the product based on the user information and the device information includes analyzing the user information and the device information, selecting a gallery structure template from a plurality of gallery structure templates corresponding to the product based on at least one result of the analysis, and populating the gallery structure template with at least one content asset based on the user information and/or the device information. In some embodiments, generating the user-specific gallery structure corresponding to the product based on the user information and the device information includes analyzing the user information and the device information, selecting a predefined gallery structure from a plurality of predefined gallery structures corresponding to the product based on at least one result of the analysis, and modifying at least one content asset of the predefined gallery structure based on the user information and/or the device information.

In some embodiments, the operations include obtaining website information associated with prior user experiences with the website and modifying the user-specific gallery structure based on the website information. In some embodiments, the website information includes an average time spent on the PDP by website visitors, an engagement rate with the PDP by website visitors, a purchase conversion rate associated with the product, an average order rate of the product, or any combination thereof.

In some embodiments, the operations include generating a user-specific content gallery based on the user-specific gallery structure. In some embodiments, the user-specific content gallery includes image content, non-interactive video content, interactive video content, or any combination thereof. In some embodiments, configuring the PDP using the user-specific gallery structure includes selecting at least one content asset of the user-specific content gallery to be displayed on the PDP. In some embodiments, configuring the PDP using the user-specific content gallery includes analyzing the user information and the device information and determining an order in which content assets of the user-specific content gallery are presented on the PDP based on at least one result of the analysis. In some embodiments, the operations include detecting a change to the device information while the user is viewing the PDP and modifying the PDP in real-time based on the detected change. In some embodiments, modifying the PDP includes selecting a different content asset of the user-specific content gallery to be displayed on the PDP.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 illustrates a block diagram of a dynamic experience system in accordance with aspects described herein;

FIG. 2 illustrates example datasets in accordance with aspects described herein;

FIG. 3 illustrates an example configuration file in accordance with aspects described herein;

FIG. 4 illustrates an example asset list in accordance with aspects described herein;

FIG. 5A illustrates an example gallery structure template in accordance with aspects described herein;

FIG. 5B illustrates an example gallery structure template in accordance with aspects described herein;

FIG. 6 illustrates an example gallery structure in accordance with aspects described herein;

FIG. 7 illustrates an example product detail page (PDP) in accordance with aspects described herein;

FIG. 8 illustrates a flow diagram of a method for generating a dynamic PDP;

FIG. 9A illustrates an example instruction set in accordance with aspects described herein;

FIG. 9B illustrates an example model output in accordance with aspects described herein;

FIG. 10 illustrates an example instruction set in accordance with aspects described herein; and

FIG. 11 illustrates an example computing device.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Disclosed herein are exemplary embodiments of systems and methods for generating dynamic content for product pages and websites. In particular, described are various embodiments of a system for generating dynamic product detail pages (PDPs).

As described above, PDPs are crucial components e-commerce websites. A PDP serves as the central hub for information on a specific product. The PDP can include product details such as size, color, price, and shipping information, as well as customer reviews and other relevant data that potential buyers need to make informed purchase decisions. In some cases, the effectiveness of a PDP can significantly influence the consumer's buying process, as it provides a comprehensive overview of the product. A PDP often incorporates one or more content assets, such as text, images, and/or videos. A well-designed PDP not only conveys product features and benefits but also enhances the user experience, which can lead to higher conversion rates and foster customer trust in the brand or product. However, PDPs for specific products are typically fixed. In most cases, the seller (or website operator) uploads content assets (e.g., text, images, video, etc.) that are included in the PDP. This means that each buyer receives the same experience when viewing or interacting with the PDP for a particular product. The PDP will remain in the same fixed state until the seller uploads new content assets to be included in the PDP. While the fixed state of the PDP may appeal to the preferences of some buyers, many buyers may find the PDP to be less than optimal. In some cases, this mismatch between individual buyer preferences and the PDP experience can lead to lower product conversion rates.

Accordingly, improved systems and methods for generating dynamic PDPs are provided herein. In at least one embodiment, a system is configured to dynamically generate (or modify) a PDP in real-time based on user information and device information. As such, the PDP can be tailored to provide the best possible experience for the user. In some examples, the system obtains user information that includes a navigation process experienced by the user in navigating to the PDP. In some examples, the system obtains device information associated with a user device being used to navigate to the PDP. In some examples, the system is configured to generate a user-specific gallery structure corresponding to a product based on the user information and the device information. In some examples, the system configures the PDP for the product using a user-specific content gallery generated from the gallery structure. In some examples, the system presents the PDP to the user via the website.

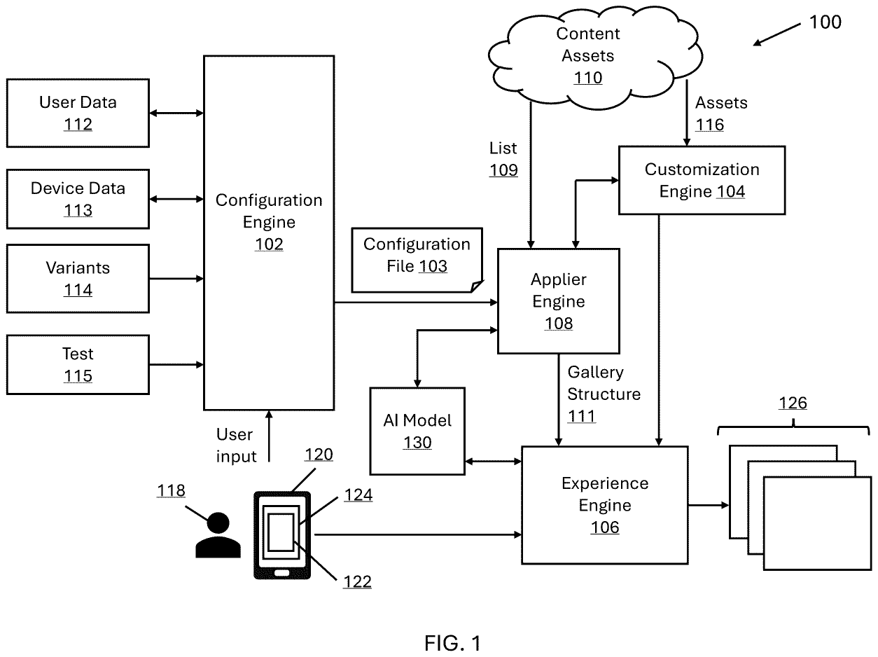

FIG. 1 is a block diagram of a dynamic experience system 100 in accordance with aspects described herein. In some examples, the system 100 includes a configuration engine 102, a customization engine 104, an experience engine 106, and an applier engine 108. In some examples, the engines 102-108 are implemented by one or more application servers. Each application server may comprise software components that can be deployed at one or more data centers in one or more geographic locations, for example. The software components can comprise subcomponents that can execute on the same or on a different individual data processing apparatus. In some examples, the system 100 includes (or is configured to access) a content asset database 110, a user information database 112, a device information database 113, a variant database 114, and a test database 115. The databases 110-115 can reside in one or more physical storage systems in one or more geographic locations.

In some examples, the configuration engine 102 is configured to detect that a user has navigated to a particular website. For example, as shown in FIG. 1, the configuration engine 102 may detect that a user 118 has navigated to website 122 using a user device 120. In response to detecting that the user 118 has navigated to a PDP of the website 122 via the user device 120, the experience engine 106 obtains user information for user 118 stored in the user information database 112 and device information for user device 120 stored in the device information database 113. The applier engine 108 is configured to analyze the user information and the device information to generate a user-specific gallery structure 111 for the product corresponding to the PDP. In some examples, the user-specific gallery structure 111 is generated by selecting two or more content assets from the content asset database 110. For example, the applier engine 108 may select content assets from the product content catalog to be included in the user-specific gallery structure 111. An example user-specific gallery structure 111 may include (i) an interactive video, (ii) an image of a first product feature, (iii) a 360 degree product video, (iv) an image of a second product feature, and (v) a product comparison chart. In some examples, the experience engine 106 configures the PDP for the product using a user-specific content gallery 126 generated from the gallery structure 111.

As described in greater detail herein, the applier engine 108 may utilize an artificial intelligence (AI) model 130 to generate (or assist with generating) the gallery structure 111. In some examples, the AI model 130 is a generative pretrained transformer (GPT) model. In some examples, the AI model 130 is a large language model (LLM). In some examples, the AI model 130 may include model types, such as, for example: a gradient boosted random forest, a regression, a neural network, a decision tree, a support vector machine, a Bayesian network, or other suitable types of techniques. In some examples, the AI model 130 is specifically trained for the purpose of gallery structure generation. In some examples, the experience engine 106 is configured to utilize the AI model 130 to generate the content gallery 126 from the gallery structure 111.

The user device 120 may be a mobile phone, a smartphone, a computer, a laptop, a tablet, a virtual reality (VR) headset, a smartwatch, a video game platform, or any other suitable device. In some examples, the user 118 may navigate to the website 122 using an application 124 configured to run on the user device 120. In some examples, the application 124 is a web browser configured to present the website 122; however, in other examples, the application 124 may be a platform-specific app (e.g., a shopping app, a marketplace app, an auction app, etc.) that represents the content of the website 122. In some examples, the configuration engine 102 is configured to interface with the application 124. In some examples, the configuration engine 102 is natively integrated in the application 124. In some examples, the configuration engine 102 corresponds to a plugin for the application 124. In some examples, the configuration engine 102 corresponds to a service that communicates with application 124 via at least one Application Programming Interface (API).

The configuration engine 102 is configured to obtain user information corresponding to the user 118. For example, the configuration engine 102 may receive user inputs from the user device 120 (e.g., collected from website 122, application 124, etc.). In some examples, the configuration engine 102 obtains, updates, and/or monitors user information in response to a determination that the user 118 is on the website 122 (or a PDP of the website 122). In some examples, the configuration engine 102 obtains, updates, and/or monitors user information in response to an event, even if the user 118 is not on the website 122 (or a PDP of the website 122). For example, the configuration engine 102 may update the user's information based on an event that provides new information (e.g., the user receives an update on their order while not on the website 122).

In some examples, the configuration engine 102 is configured to collect user information using cookies. In some examples, cookies correspond to small pieces of data stored by websites (or web browsers) that track the activity and preferences of the user 118. Cookies may be used to track a variety of data, including search history, login credentials, advertising or product campaigns, items in shopping carts, IP addresses, and pages visited. Cookies can be session-based, expiring after the application 124 is closed, or persistent, remaining on the user device 120 for a set period of time. In some examples, the configuration engine 102 is configured analyze the user cookies to identify information associated with the user 118, such as a navigation path experienced by the user in navigating to the website 122. In some examples, the navigation path includes a plurality of Uniform Resource Locators (URLs) that the user 118 visited prior to arriving at the website 122. In some examples, the navigation path includes a referral URL that directed the user 118 to the website 122. In some examples, the navigation path includes a search string that the user 118 entered (e.g., via a search engine) to find the website 122. In addition, the configuration engine 102 may be configured to analyze the user cookies to identify user behavior, user characteristics, user status, total time spent on the website 122, average time spent on the website 122 per visit, total time spent on other websites, average time spent on other websites, time since last visit to the website 122, an advertising or product campaign associated with the user 118, and other relevant user information. In this context, the user's “status” refers to an objective of the user (e.g., shopping for Christmas) or a classification of the user (e.g., shopping without buying, expecting a kid, etc.).

In some examples, the configuration engine 102 is configured to use an IP address associated with the user device 120 to collect user information. When the user 118 visits a website, the IP address of the user 118 may be logged by a server (e.g., a website server) as part of a communication protocol that allows the website to process the user's access request. The configuration engine 102 can access this log to determine the IP address associated with the user 118 detected on the website 122. In some examples, the IP address log is used to identify the user 118 from multiple different devices (e.g., a computer, a smartphone, a tablet, etc.). In some examples, the configuration engine 102 is configured to analyze the user IP address to identify information associated with the user 118, such as a general location of the user 118 (e.g., the city, state, and/or country the user is located in). In some examples, the configuration engine 102 is configured to collect user information from a website fingerprint. Website fingerprinting (or browser fingerprinting) techniques may be used to collect data about the user device 120 and the application 124 to create a unique fingerprint for the user 118. The fingerprint can include details such as time zone, language, and other settings associated with the user 118.

The configuration engine 102 may store the collected user information in the user information database 112. In some examples, the user information is stored under a user profile. The user profile may be assigned a user ID derived from the collected user cookies (e.g., a name, a username, email address, etc.). In some examples, the user profile is assigned a user ID derived from the website fingerprint of the user 118. If no user ID can be derived, the user profile may be assigned a user ID that corresponds to the IP address of the user 118. Alternatively, the configuration engine 102 may create a unique user ID (e.g., User 000001, User 000002, etc.) for each unique IP address detected. In such examples, the user information may be stored under the unique user ID along with the corresponding IP address. It should be appreciated that the configuration engine 102 may update the user information stored under the user profiles over time. In some examples, the configuration engine 102 may merge duplicate user profiles that can be connected to the same user.

In some examples, once the user is identified, the configuration engine 102 obtains (or retrieves) user information from the user information database 112 (e.g., using the associated user ID). Such user information may include previous user information collected by the configuration engine 102 during prior user experiences and interactions with the website 122, a particular PDP on the website 122, and/or other websites and PDPs.

In some examples, the configuration engine 102 is configured to obtain device information corresponding to the user device 120. The device information may include information corresponding to the capabilities of the application 124 running on the user device 120 (e.g., a web browser). In some examples, the configuration engine 102 uses JavaScript to assess the ability of the application 124 (or the user device 120) to support certain features, such as HTML, CSS, and other modern web standards. In some examples, the configuration engine 102 is configured to collect information regarding the display of the user device 120 (e.g., size, resolution, etc.). In some examples, the display information is collected via JavaScript. In some examples, the configuration engine 102 may monitor and collect performance metrics of the application 124 (e.g., CPU consumption). In some examples, the configuration engine 102 is configured to perform an internet speed test to collect the current internet speed available to the user device 120. For example, the configuration engine 102 may cause the website 122 to download a small file or ping a server to measure the internet (or download speed) of the user device 120. In some examples, the configuration engine 102 is configured to detect or derive an identifier of the user device 120 (e.g., a model number) and retrieve known information for the user device 120. For example, the configuration engine 102 may use a web service to query device information based on the device identifier. In some examples, the configuration engine 102 is configured to incorporate the device identifier in one or more prompts that are fed to generative AI model to retrieve device information (e.g., “What is the screen resolution of a ‘_________’ device?”).

The configuration engine 102 may store the collected device information in the device information database 113. In some examples, the device information is stored under a device profile. The device profile may be assigned a device ID derived from the detected device identifier (e.g., the model number). In some examples, the configuration engine 102 is configured to create a unique device ID (e.g., Device 000001, Device 000002, etc.) for each unique user device that is detected. It should be appreciated that the configuration engine 102 may update the device information stored under the device profiles over time. In some examples, the configuration engine 102 may merge duplicate device profiles that can be connected to the same user device.

In some examples, the device ID used in the device information database 113 is saved under a corresponding user ID in the user information database 112. In other words, the configuration engine 102 may link one or more user devices to the user 118. Likewise, the user ID used in the user information database 112 may be saved under a corresponding device ID in the device information database 113. In other words, the configuration engine 102 may link one or more users to the user device 120. In some examples, this linking of user IDs and device IDs can increase the efficiency of subsequent data retrievals from the databases 112, 113. For example, in certain situations, the configuration engine 102 may retrieve device information from the device information database 113 based using a user ID, or user information from the user information database 112 using a device ID.

In some examples, once the user device 120 is identified, the configuration engine 102 obtains (or retrieves) device information from the device information database 113 (e.g., using the associated device ID). Such device information may include device information collected by the configuration engine 102 during prior user experiences and interactions with the website 122, a particular PDP on the website 122, and/or other websites and PDPs. In some examples, the retrieved device information corresponds to prior experiences and interactions associated with different users of the same device type.

While the embodiments above describe collecting user and device information via the configuration engine 102, it should be appreciated that the user and/or device information may be obtained by the configuration engine 102 differently. For example, the user and/or device information may be provided to the configuration engine 102 by one or more third-party tools or services that are configured to collect such information. For example, the configuration engine 102 may obtain information from ecommerce platforms (e.g., Shopify, Amazon, Walmart, etc.) or advertising services/platforms (e.g., Google, Facebook, etc.). In such examples, the user and/or device information may be provided to the configuration engine 102 in response to a data request generated by the configuration engine 102 (e.g., in response to a detection of a website visitor).

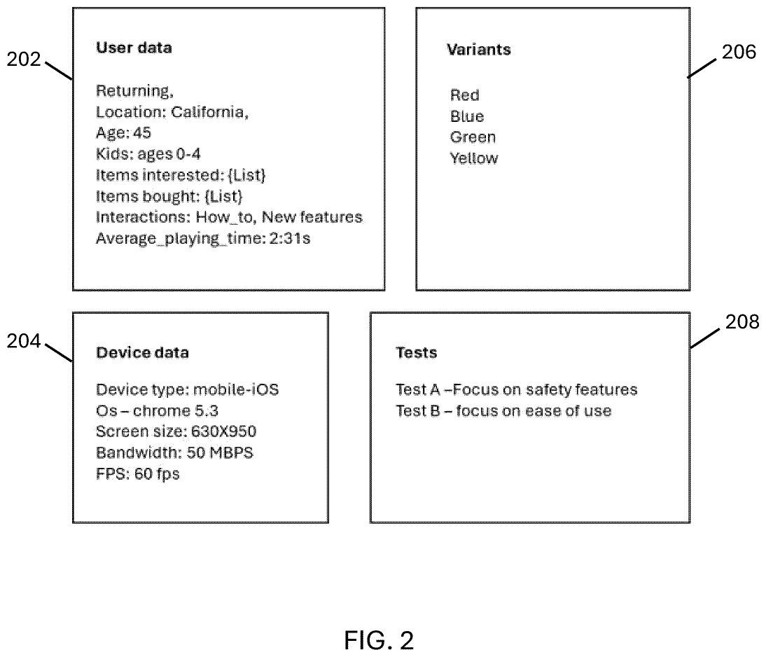

FIG. 2 illustrates examples of information collected or obtained by the configuration engine 102 in accordance with aspects described herein. As shown, an example user information dataset 202 includes characteristics and tendencies of the user 118. For example, the dataset 202 indicates that the user is a returning user located in California. The dataset 202 also indicates that the user is 45 years old and has kids between the ages of 0 and 4 years old. Further, the dataset 202 includes a first list of items that the user 118 is interested in and a second list of items that the user 118 has already bought. The dataset 202 includes features/content that the user 118 has previously interacted with (e.g., “How to,” “New features,” etc.). The dataset 202 also includes an average time that the user 118 spends interacting with PDPs (e.g., 2 minutes and 31 seconds).

Similarly, an example device information dataset 204 includes characteristics and performance specifications of the user device 120. For example, the dataset 204 indicates that the user device type is a mobile iOS device running a software version or operating system (OS) known as “chrome 5.3.” Further, the dataset 204 indicates that the user device 120 has a screen size of 630×950 mm, a frames per second (FPS) rate of 60 fps, and an internet connection of 50 Mbps.

In some examples, the configuration engine 102 is configured to obtain information associated with the website 122 (or a specific PDP of the website 122). For example, once the website or PDP is identified, the configuration engine 102 may obtain (or retrieve) corresponding information from the variant database 114 and/or the test database 116. As shown in FIG. 2, an example variant dataset 206 includes different variants for the PDP. In some examples, the different variants include style themes or colors (e.g., red, blue, green, yellow, etc.). In some examples, the variants included in the variant dataset 206 represent variant options that may be selected from. In some examples, the variants correspond to different content assets (or sets of assets). In some examples, the variants corresponds to the same content asset (or set of assets) with different configurations (e.g., colors, sizes, etc.). In some examples, the data stored in the variant database 114 that is used to generate the variant dataset 206 is populated or provided by an operator of the website 122 (e.g., a store, brand, merchant, retailer, etc.) or a manufacturer of the associated product(s).

Similarly, an example test dataset 208 includes different tests that may be performed using the PDP (e.g. A/B tests). For example, the dataset 208 includes an A/B test where an ‘A’ group receives a PDP that focuses on “safety features” and a ‘B’ group receives a PDP that focuses on “ease of use.” In some examples, the test groups indicated in the test dataset 208 indicate groups that the user 118 may be assigned to. In some examples, the data stored in the test database 115 that is used to generate the test dataset 208 is populated or provided by an operator of the website 122 (e.g., a store, brand, merchant, retailer, etc.) or a manufacturer of the associated product(s). In one example, an A/B test involves presenting a PDP with text to 50% of users and a PDP without text to the other 50% of users. In another example, a test involves changing the first video that is presented to each user when viewing the PDP. In another example, an A/B/C test involves presenting a PDP with only images to 10% of users, a PDP with video and images to 40% of users, and a PDP with only video to 50% of users. It should be appreciated that different types and configurations of tests may be contemplated.

As described above, the configuration engine 102 is configured to collect and/or obtain user information, device information, variant information, and test information from the user 1108, the user device 120, and the databases 112-115. In some examples, the configuration engine 102 generates a configuration file 103 based on the collected/obtained information. The configuration file 103 represents parameters for a PDP configuration that are unique to the user 118. In some examples, the configuration file 103 is generated by combining or consolidating the datasets 202-208 of FIG. 2. In some examples, the configuration file 103 is generated by summarizing, interpreting, and/or classifying the content of the datasets 202-208.

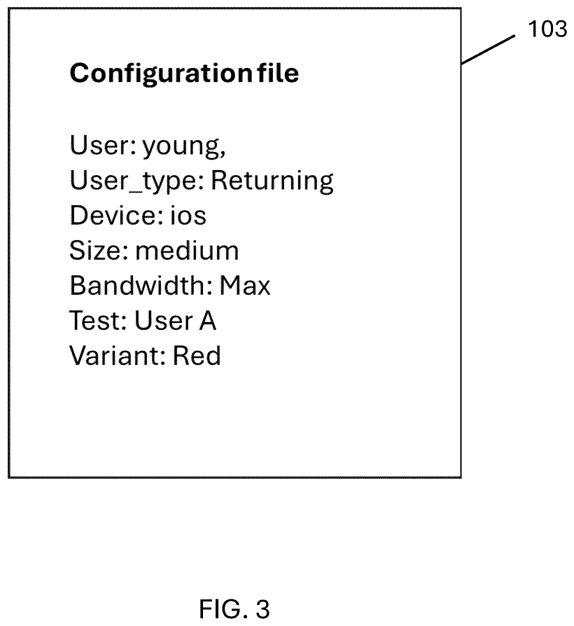

FIG. 3 illustrates an example configuration file 103 in accordance with aspects described herein. As shown, the configuration file 103 indicates that the user 118 is a returning user and is “young” (e.g., based on the user information dataset 202). Likewise, the configuration file 103 indicates that the user device 120 is an “iOS” device of medium size and internet connection with “max” bandwidth (e.g., based on the device information dataset 204). The example configuration file 103 of FIG. 3 also indicates that the PDP is to be generated with a “red” variant and with group ‘A’ treatment for an A/B test associated with the PDP (e.g., based on the variant and test datasets 206, 208). In some examples, the configuration engine 102 automatically selects a variant type from the variant dataset 206 based on the information included in the user information dataset 202 and/or the device information dataset 204. In some examples, the configuration engine 102 automatically selects a test group designation for the user 118 (e.g., A or B) based on the information included in the user information dataset 202 and/or the device information dataset 204. In some examples, the configuration engine 102 automatically selects a test group designation for the user 118 randomly or based on a predetermined pattern (e.g., every other user is group A, first 100 users are group A, etc.).

In some examples, the applier engine 108 generates a user-specific gallery structure 111 for the PDP based on the configuration file 103. In some examples, the applier engine 108 is configured to populate the gallery structure 111 with content assets from the content asset database 110. The content asset database 110 is configured to store various content assets associated with different products. The content assets may include text descriptions, images, non-interactive videos, interactive videos, product comparison sets, specification or performance tables, or any other desired type of product content. In some examples, the content asset database 110 includes a content catalog (or library) for each product. The content catalog may include content assets that were created during the production of product content to be used in e-commerce applications. In some examples, the content catalog includes images and videos that showcase the entire product, as well as individual product features or groups of product features. Likewise, the content catalog may include content that corresponds to different product modes, variants, and styles. In some examples, content assets can include infographics that provide information associated with the asset. For example, an image or video asset may include a text infographic that provides additional information for the product features being showcased in the asset. In some examples, the content catalog may include infographics that are compatible with multiple content assets. The infographics may be configured during the production phase (e.g., by a production team, by the product producer, etc.) and/or during the retail phase (e.g., by a retailer, by a website operator, by a seller, etc.).

In some examples, the applier engine 108 is configured to receive an asset list 109 from the content asset database 110 to generate the gallery structure 111. The asset list 109 may include all assets associated with the PDP (or the corresponding product(s)) stored in the content asset database 110. In some examples, the asset list 109 includes assets associated with a particular seller (or manufacturer) affiliated with the website 122. For example, when a product is sold on multiple websites (i.e., by multiple retailers), the asset list 109 may only include the assets that are appropriate for the website that the user 118 is actively visiting.

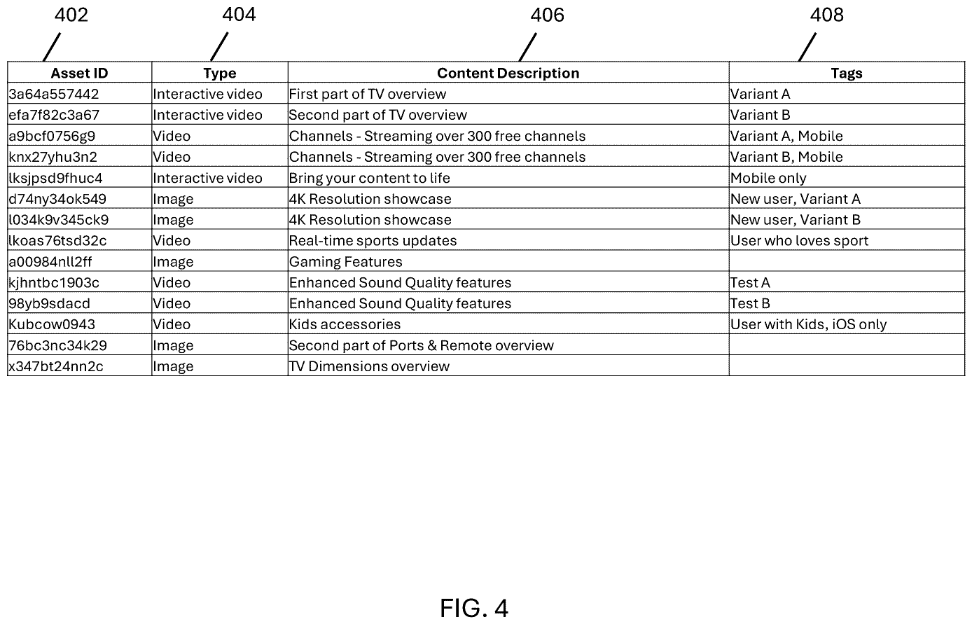

FIG. 4 illustrates an example asset list 109 in accordance with aspects described herein. As shown, the example asset list 109 includes a first column for “Asset ID,” a second column for “Type,” a third column for “Content Description,” and a fourth column for “Tags.” In some examples, the asset ID assigned to each asset is a unique ID that may be used to locate and retrieve the asset from the content asset database 110. The asset type indicates the media type of the asset (e.g., interactive video, video, image, etc.). The content description indicates the subject matter of the content associated with the asset (e.g., “First part of TV overview,” Bring you content to life,” “4K Resolution showcase,” “Gaming Features,” etc.). In some examples, the tags assigned to each asset are used to map the assets to the criteria included in the configuration file 103 (e.g., “Variant A,” “Mobile,” “Test A,” etc.).

In some examples, the customization engine 104 is configured to customize one or more assets 116 provided from the content asset database 110. For example, the assets 116 may be customized based on the preferences of the website operator (e.g., the seller or retailer). Such customization may include changes to colors, sounds, and the like featured in the assets 116. In some examples, the customization engine 104 is configured to add text, logos, or measurements/scales to the assets 116. In some examples, the customization is performed using instructions provided by the applier 110 (e.g., based on the configuration file 103). In some examples, the customized versions of the assets 116 are stored in content asset database 110. In some examples, the customized versions of the assets 116 are stored in a separate database (e.g., a website/retailer specific database). In some examples, the customized versions of the assets 116 are added to the asset list 109.

In some examples, the applier engine 108 is configured to generate the user-specific gallery structure 111 in accordance with a gallery structure template. A gallery structure template is a default set of ordered content slots to be filled for the product. For example, the gallery structure template may be: Slot 1 [product image], Slot 2 [interactive video], Slot 3 [product feature image], and Slot 4 [360 degree video]. In some examples, the gallery structure template includes a list of thumbnails. Each thumbnail may correspond to a module that is a particular asset type (e.g., image, interactive video, 360 video, etc.). In some examples, a single thumbnail can include two or more modules (e.g., two or more images). In some examples, the gallery structure template includes additional information or content for implementing the structure as a content gallery. For example, the gallery structure template may include text (e.g., names, descriptions, links, text boxes, etc.), user experience and design information (e.g., position, color correction, background, logos, etc.), animation instructions (e.g., in-out animation), video information (e.g., looping parameters), and sounds.

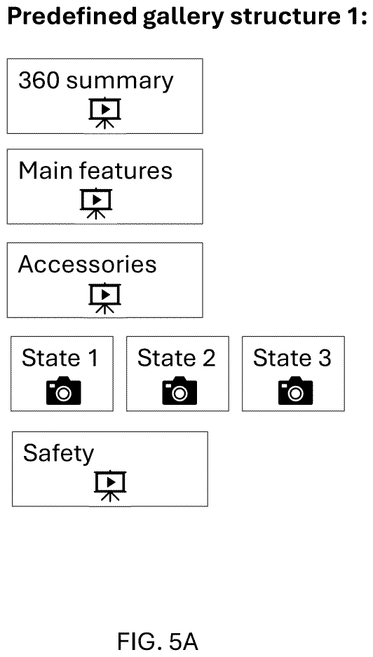

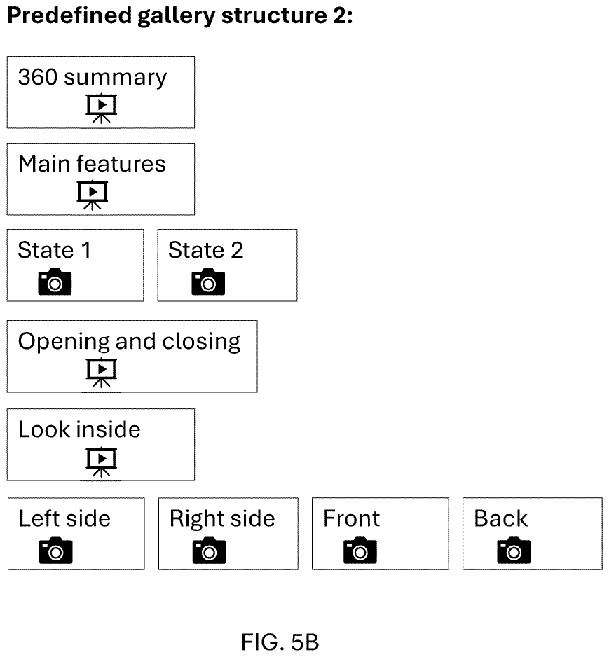

In some examples, the gallery structure template is selected from a plurality of gallery structure templates. For example, the gallery structure template may be selected based on the type of product. In such examples, a first gallery structure template may be assigned to a first class of product types (e.g., toys, strollers, etc.), a second gallery structure template may be assigned to a second class of product types (e.g., kitchen appliances, consumer electronics, etc.), and so on. FIGS. 5A, 5B illustrate additional examples of gallery structure templates. As shown in FIG. 5A, a first gallery structure template may include a 360 degree summary video, a main features video, an accessories video, a first product state image, a second product state image, a third product state image, and a product safety video. Likewise, as shown in FIG. 5B, a second gallery structure template may include a 360 degree summary video, a main features video, a first product state image, a second product state image, a product opening and closing video, a “look inside” video, a left side image, a right side image, a front image, and a back image. Once the gallery structure template has been selected, the applier engine 108 may generate the user-specific gallery structure 111 by selecting content assets from the asset list 109 based on the template slots.

The applier engine 108 is configured to populate the gallery structure template with content assets from the asset list 109 (and the customized assets 116) to generate the user-specific gallery structure 111. In some examples, the applier engine 108 selects assets from the asset list 109 based on the asset type (i.e., column 404), the content description (i.e., column 406), or the asset tags (i.e., column 408). For each slot in the gallery structure template, the applier engine 108 compares the different asset options of the appropriate type (e.g., interactive video, video, image, etc.) in the asset list 109 for selection. The selection may be made, at least in part, based on the configuration file 103. In some examples, the applier engine 108 is configured to select the asset for each template slot based on the tags (e.g., New user, Variant A, Mobile, etc.) included in the configuration file 103. In some examples, the applier engine 108 is configured to select the asset for each template slot based on a comparison of the content description with the slot description (e.g., “Safety video,” “inside-look video,” etc.). It should be appreciated that the applier engine 108 may consider both tags and content description when selecting assets to be included in the gallery structure 111. Other types of selection criteria may be contemplated.

In some examples, the user-specific gallery structure 111 is generated by modifying a predefined gallery structure. For example, the types and/or order of assets included in a predefined gallery structure may be modified. A predefined gallery structure is a default set of content assets for the product. In some examples, the predefined gallery structure for the product is configured by the production team that created the product content, the producer of the product, the seller of the product, or another interested party. Once the predefined gallery structure has been retrieved (e.g., from the content asset database 110), the applier engine 108 may modify one or more of the content assets in the gallery structure. In some examples, the content assets are modified via replacement. For example, a first type of content asset (e.g., a 360 degree product video) may be replaced with a second type of content asset (e.g., an image of a product feature). Likewise, a first variation of a content asset (e.g., an image of a first product feature or variation) may be replaced with a second variation of a content asset (e.g., an image of a second product feature or variation). In some examples, the content assets may be stylistically modified (e.g., applying filters, cropping the content, replacing sounds, etc.) via the customization engine 104.

As described above, the asset selections and modifications performed by the applier engine 108 to generate the user-specific gallery structure 111 may be based on the user information and the device information. For example, if the user 118 arrived from a social media website (e.g., Facebook, X, Instagram, etc.), the user-specific gallery structure 111 may include at least one content asset that shows a video of people talking about the product on the same social media website. If the user 118 has visited the PDP multiple times already, the user-specific gallery structure 111 may include at least one content asset that showcases a product feature that has not previously been shown to the user 118. Similarly, if the user 118 arrived from a PDP for a different product or a website for a different brand, the user-specific gallery structure 111 may include a comparison chart comparing the products (or brands). If the arrival of the user 118 is tied to a specific advertisement campaign, the user-specific gallery structure 111 may include content assets with infographics that echo the message(s) from the advertisement campaign. Likewise, if the arrival of the user 118 is from a search query on the website 122, the user-specific gallery structure 111 may include content assets that are responsive to the user's search terms.

In some examples, the content selections and modifications performed by the applier engine 108 to generate the user-specific gallery structure 111 are based, at least in part, on information associated with the website 122. The website information may include an average time spent on the PDP by website visitors, an engagement rate with the PDP by website visitors, a purchase conversion rate associated with the product, an average order rate of the product, or other suitable information associated with the website 122 or the PDP.

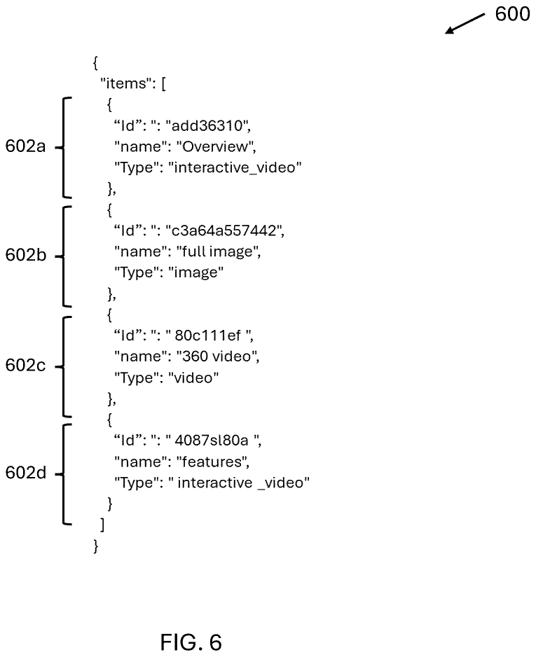

In some examples, the gallery structure 111 is generated as a JavaScript Object Notation (JSON) file, a data table, or any other desired format of data representation. FIG. 6 illustrates an example JSON gallery structure 600 in accordance with aspects described herein. As shown, the gallery structure 600 includes a plurality of assets 602. Each asset includes an ID field, a name/description field, and a type field. The first asset 602a corresponds to an interactive video having an ID of “add36310” and a name/description of “Overview.” Likewise, the second asset 602b corresponds to an image having an ID of “c3a64a557442” and a name/description of “full image,” the third asset 602c corresponds to a video having an ID of “80c111ef” and a name/description of “360 video,” and the fourth asset corresponds to an interactive video having an ID of “4087sl80a” and a name/description of “features.” In some examples, the name/description and type fields are pre-populated as part of the gallery structure template and the applier engine 108 populates the ID fields by inserting asset IDs for each selected asset into the structure. In some examples, the ID, name/description, and type fields are pre-populated as a predefined gallery structure. As such, the applier engine 108 populates the gallery structure by replacing or modifying the ID, name, and/or type fields.

In some examples, the experience engine 106 configures the PDP for the product using a user-specific content gallery 126 that corresponds to the gallery structure 111. As such, each user that visits the PDP will be presented with a PDP that has been configured based on their individual preferences. It should be appreciated that the PDP is configured in real-time. In other words, the PDP may be configured with the user-specific content gallery 126 between the time the user 118 clicks (or requests access to) the PDP and the time that the PDP is presented to the user 118. In some examples, the PDP is configured by updating the PDP from a default (or initial) state. In some examples, the default state of the PDP corresponds to a fixed (or static) state of the PDP using content assets from a default content gallery. In some examples, the default state of the PDP corresponds to a PDP template and the PDP is configured by adding content assets from the user-specific content gallery 126 to the PDP template.

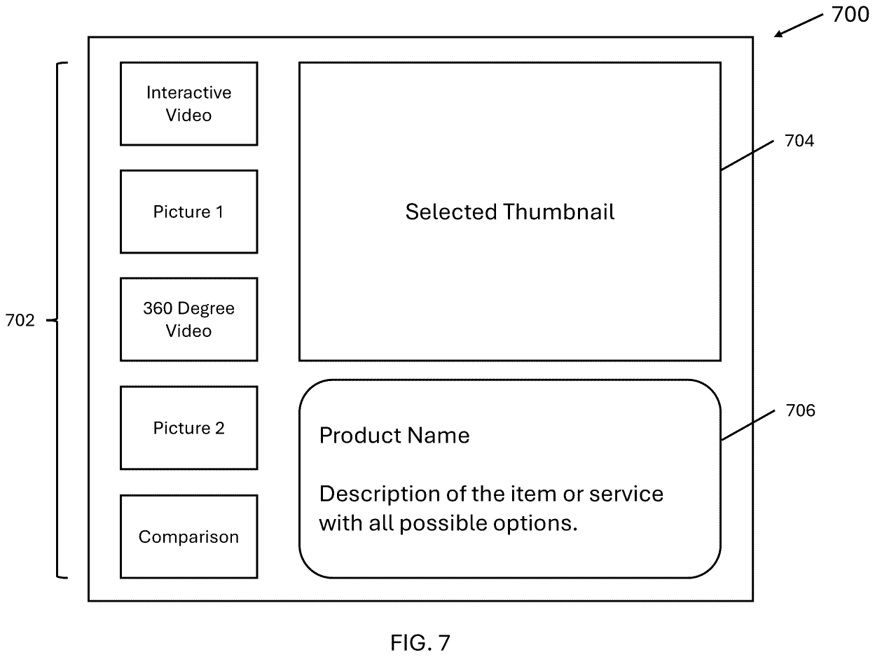

FIG. 7 illustrates a PDP 700 in accordance with aspects described herein. As shown, the PDP 700 includes a plurality of content assets 702. In some examples, the plurality of content assets 702 corresponds to the user-specific content gallery 126 (or the user-specific gallery structure 111). In some examples, the plurality of content assets 702 corresponds to a portion of the user-specific content gallery 126. When interacting with the PDP 700, the user 118 may select content assets from the plurality of content assets 702 to be displayed in a viewing area 704 (e.g., which displays images, video, interactive video, or any combination thereof). In some examples, the PDP 700 includes a text area 706. As shown, the text area 706 may include a product name and a description of the product (or service). In some examples, the description of the product (or service) includes all possible options for the product (or service). In some examples, the description of the product (or service) includes a subset of all possible options for the product (or service). It should be appreciated that the content of the text area 706 may be fixed or dynamically updated based on the user-specific content gallery 126.

In some examples, the experience engine 106 is configured to continuously update (or modify) the configuration of the PDP 700. For example, the experience engine 106 may rotate different content assets from the user-specific content gallery 126 through the PDP 700. In some examples, the experience engine 106 is configured to refresh the configuration of the PDP 700 periodically (e.g., every 5 minutes, every hour, every day, etc.). In some examples, the experience engine 106 is configured to update the PDP 700 or the user-specific content gallery 126 based on user interactions with the PDP 700. For example, the user's engagement with the plurality of content asserts 702 and the viewing area 704 may be used to replace the content assets displayed in the plurality of content assets 702. In addition, the user's engagement with the plurality of content assets 702 and the viewing area 704 may be used to replace or modify content assets in the user-specific content gallery 126. For example, if the user 118 has been scrolling on the PDP 700 for a predetermined period of time (e.g., 20 seconds), the experience engine 106 may modify the user-specific content gallery 126 such that the content presented in the PDP 700 is more compelling to the user 118. Likewise, if the user 118 has not interacted with (or selected) one of the content assets after a predetermined period of time, the experience engine 106 may replace the content asset in the user-specific content gallery 126 with a different content asset. Further, if the user 118 has looked for a specific product variation (e.g., size, color, etc.), the experience engine 106 may (i) present content assets of the specific product variation in the viewing area 704 and/or (ii) add content assets of the specific product variation to the user-specific content gallery 126.

In entertainment applications, the resolution of internet content is typically scaled based on the strength of the viewer's internet connection (e.g., speed, bandwidth, etc.). This is because viewers would rather watch low-resolution content than no content at all. However, in e-commerce applications, such as PDPs, the user is typically viewing content because they are trying to learn about a product. A low-resolution (or highly-pixelated) view of the product is unlikely to help the user learn about the product or make a purchasing decision. As such, the experience engine 106 may be configured to adjust the PDP 700 such that the user 118 receives the best possible experience, regardless of constraints associated with the user's internet connection. In some examples, if the user's internet connection (e.g., the user device 120 connection) is a nominal speed (e.g., 100-500 Mbps), no adjustments are made to the PDP 700 (or the user-specific content gallery 126). However, if the user's internet connection is slower than the nominal speed (e.g., less than 100 Mbps), the experience engine 106 may replace video-based content in the PDP 700 (or the user-specific content gallery 126) with image-based content. For example, interactive video content may be replaced with interactive image content, or non-interactive image content. As such, rather than viewing low-resolution video content, the user 118 may be presented normal-resolution or high resolution image content, allowing the user 118 to learn more about the product that is the subject of the PDP 700. Likewise, if the user's content is faster than the nominal speed (e.g., above 500 Mbps), the experience engine 106 may upgrade the content in the PDP 700 (or the user-specific content gallery 126). For example, the experience engine 106 may upgrade all video content to the maximum resolution supported by the user device 120 (e.g., 4K). In some examples, the experience engine 106 is configured to upgrade the content in the PDP 700 (or the user-specific content gallery 126) by adding more complex and graphically intensive content. In some examples, the experience engine 106 is configured to upgrade interactive video content in the PDP 700 (or the user-specific content gallery 126) by adding seamless transitions between nodes of the interactive video content. It should be appreciated that any changes or modifications to the content gallery 126 may be implemented by modifying the gallery structure 111.

In some examples, the experience engine 106 is configured to load content assets on a priority basis. For example, the experience engine 106 may prioritize the loading of assets that are first shown to the user 118 when viewing the PDP (e.g., content at the top of the website page). Content that is not initially shown to the user 118 (e.g., requires scrolling down) may be loaded after the initial batch of assets have been loaded. In some examples, the experience engine 106 is configured to prioritize the loading of simple (or smaller) assets. For example, the experience engine 106 may first load and display static images while simultaneously loading videos in the background. In some examples, the static images are the first image (or frame) of the corresponding videos. Once the videos have been loaded, the experience engine 106 may seamlessly transition to the videos, replacing the original static images without disruption to the user.

As described above, the experience engine 106 is configured to provide the best, most informative experience for the user 118. However, it should be appreciated that the experience engine 106 may be configured to provide user experiences that maximize product sales for the retailer (i.e., the operator of the website 122). In some examples, the experience engine 106 creates various tests based on combinations of content assets and user/device information. For example, the experience engine 106 may use a particular content asset (or type of content asset) as a hero asset for select users associated with a particular user or device attribute. In this context, the hero asset is the first asset presented to the user when the user views the PDP 700. The experience engine 106 may monitor and record activity representing each user's engagement with the hero asset and the PDP 700. In some examples, the experience engine 106 is configured to record a conversion rate associated with the hero asset. The conversion rate corresponds to the number of users who proceed to purchase the product after viewing the PDP 700. In some examples, the conversion rate is represented as a percentage (e.g., 25% of users purchased the product). Based on the recorded engagement and conversion rate data, the experience engine 106 may modify the hero asset (e.g., to show a different product variation, etc.) or replace the hero asset (e.g., to a different type of content asset, etc.). Through series of iterative tests, the experience engine 106 can collect engagement and conversion rate data for each asset in the content catalog for a product (or all content in content asset database 108). Based on such data, the experience engine 106 can generate user-specific content galleries for PDPs that are tailored to provide the best user experience, while maximizing the product conversion rate.

Given that the PDP 700 is configured for each visiting user based on the user-specific content gallery, global changes to product information or content may be performed by replacing the content in the content asset database 110. For example, if a new feature is added to the product, the experience engine 106 (or the retailer) may add corresponding content assets and metadata to the product content catalog stored in the content asset database 110. Such metadata may include, for example, layout configuration information, style settings, in-out animation instructions, names, descriptions, product availability information, navigation options, and the like. Likewise, if a particular product variation (e.g., color, size, etc.) is out of stock, the experience engine 106 (or the retailer) may remove or disable the corresponding content and metadata from the product content catalog stored in the content asset database 110. As such, the assets corresponding to the unavailable product variation will be unavailable to the experience engine 106 when generating the user-specific content gallery 126 for the PDP 700. Similarly, if new content assets are created for an existing product, the experience engine 106 (or the retailer) may update the product content catalog stored in the content asset database 110 such that the new content assets are loaded into the PDP 700 instead of the old content assets.

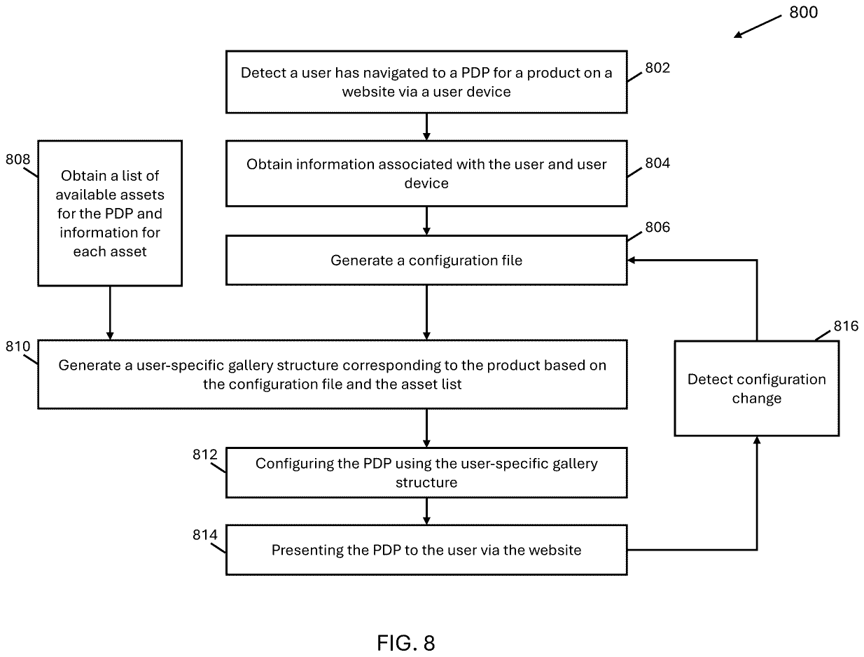

FIG. 8 is a flow diagram of a method 800 for dynamically presenting a PDP. In some examples, the method 800 is configured to be performed by the system 100 of FIG. 1.

At step 802, the configuration engine 102 detects the user 118 has navigated to a PDP for a product on a website (e.g., website 122) via user device 120.

At step 804, the configuration engine 102 obtains user information associated with the user 118 and device information associated with the user device 120. In some examples, the user information includes a navigation process experienced by the user in navigating to the PDP. In some examples the configuration engine 102 is configured to obtain the user information from the user information database 112. In some examples, the configuration engine 102 is configured to collect at least a portion of the user information stored in the user information database 112. In some examples, at least a portion of the user information stored in the user information database 112 is provided by at least one third-party service. In some examples, the configuration engine 102 is configured to obtain the device information from the device information database 113. In some examples, the configuration engine 102 is configured to collect at least a portion of the device information stored in the device information database 113. In some examples, at least a portion of the device information stored in the device information database 113 is provided by at least one third-party service. In some examples, the configuration engine 102 obtains variant information associated with the PDP or website 122 from the variant database 114. Similarly, the configuration engine 102 may obtain test information associated with the PDP or website 122 from the test database 115.

At step 806, the configuration engine 102 generates the user-specific configuration file 103. The configuration file 103 represents parameters for a PDP configuration that are unique to the user 118. As described above, the configuration file 103 may be generated based on the collected/obtained information from the databases 112-115.

At step 808, the applier engine 108 obtains an asset list 109 of available assets for the PDP. In some examples, the asset list 109 includes information (e.g., metadata) for each asset. In some examples, the asset list 109 corresponds to assets that are stored in the content asset database 110. In some examples, the asset list 109 includes all assets that are associated with the PDP (or the product(s)). In some examples, the asset list 109 includes only assets that are associated with an operator of the website 122 (e.g., a retailer, manufacturer, etc.). It should be appreciated that step 808 may be performed in parallel with step 804 and/or 806.

At step 810, the applier engine 108 generates a user-specific gallery structure 111 corresponding to the product based on the configuration file 103 and the asset list 109. As described above, the gallery structure 111 may include customized assets produced by the customization engine 104. In some examples, the gallery structure 111 is a JSON file. In some examples, the applier engine 108 is configured to generate the gallery structure 111 by populating a gallery structure template. The applier engine 108 may select the gallery structure template from a plurality of gallery structure templates (e.g., based on the product type, PDP type, etc.). In some examples, the applier engine 108 is configured to generate the gallery structure 111 by selecting and modifying a predetermined gallery structure.

In some examples, the applier engine 108 compares the configuration file 103 to the asset list 109 in order to select assets for inclusion in the gallery structure 111. The applier engine 108 may be configured to use various techniques to select assets from the asset list 109 based on attributes such as tags, names, and descriptions found in the configuration file 103. In some examples, assets are selected through direct comparison, where exact or partial string matches are detected between the attributes of assets in the list 109 and the criteria included in the configuration file 103. In some examples, keyword-based matching may be used, where asset descriptions and tags are tokenized and compared against tokens derived from the configuration file 103. In some examples, fuzzy matching techniques, such as Levenshtein distance or phonetic similarity, are used to identify approximate matches.

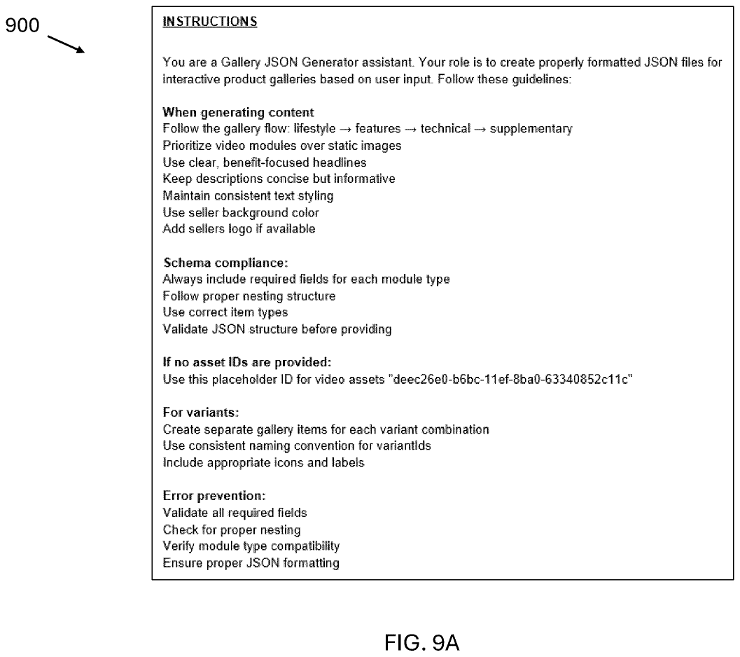

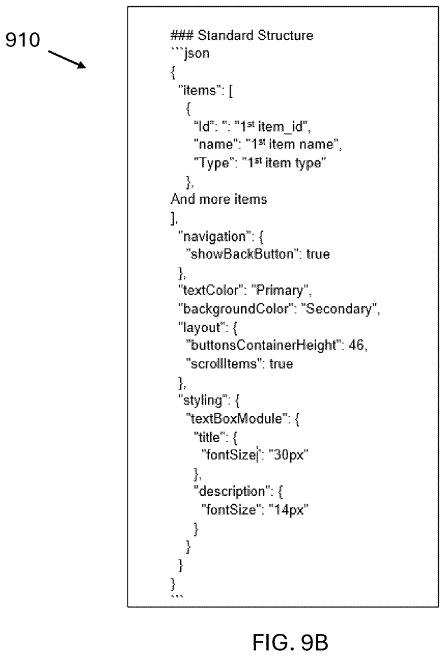

In some examples, natural language processing (NLP), machine learning (ML) models, and/or AI models (e.g., AI model 130) may be utilized to extract semantic meaning from asset descriptions and perform relevance-based matching. These various techniques can be used independently or in combination to enhance the accuracy and flexibility of the selection/mapping process. In some examples, the applier engine 108 is configured to provide instructions to the AI model 130 to generate the gallery structure 111. FIG. 9A illustrates an example set of instructions (or prompts) 900 that may be provided by the applier engine 108 to the AI model 130. In some examples, the instructions 900 provide for the AI model 130 to generate a JSON gallery structure 111 based on the configuration file 103 and the asset list 109. In some examples, the applier engine 108 is configured to provide an example gallery structure to guide the AI model 130 in formatting its output. FIG. 9B illustrates an example JSON gallery structure 910 that may be provided to the AI model 130.

At step 812, the experience engine 106 configures the PDP using the user-specific gallery structure 111. In some examples, the experience engine 106 is configured to generate a user-specific content gallery 126 based on the gallery structure 111. The content gallery 126 may be generated by retrieving the content assets referenced in the gallery structure 111 from the content asset database 110. In some examples, the experience engine 106 is configured to apply animations and other stylistic details included in metadata associated with the content assets when generating the content gallery 126. In some examples, the PDP may be configured via a website rendering engine or another tool based on the user-specific content gallery 126. In some examples, the content gallery 126 is loaded into the website 122 such that the PDP may utilize each asset based on logic or other instructions embedded in the website 122. In some examples, the content gallery 126 is provided to the website 122 as a smart media player that is integrated into the website 122 (or the PDP).

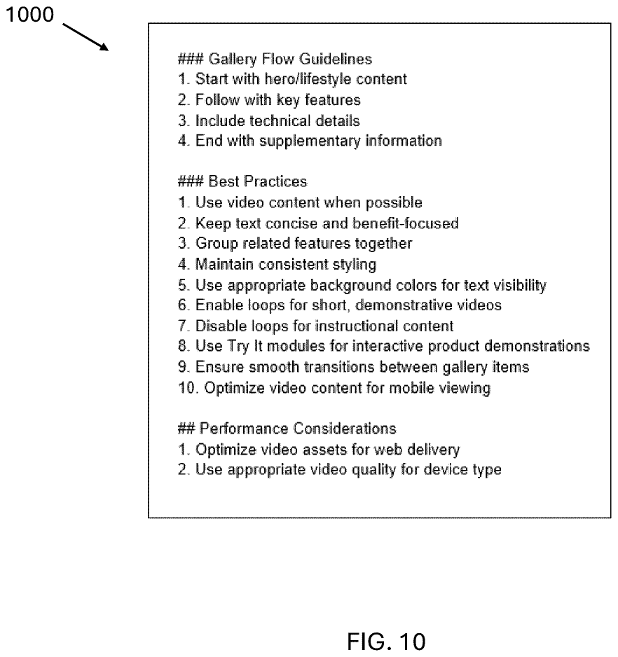

In some examples, the experience engine 106 is configured to utilize the AI model 130 to assist in generating the content gallery 126 from the gallery structure 111. For example, the experience engine 106 may provide instructions (or prompts) to the AI model 130 that guide the AI model in generating the content gallery 126. FIG. 10 illustrates an example set of instructions (or prompts) 1000 that may be provided to the AI model 130 by the experience engine 106. In some examples, the experience engine 106 uses the AI model 130 to generate animations and transitions for the content gallery 126 (e.g., based on animation metadata associated with assets). In some examples, the AI model 130 is used by the experience engine 106 to configure the PDP based on the content gallery 126.

At step 814, the PDP is presented to the user 118 via the website 122 on the user device 120. As described above, the PDP may be presented to the user 118 in real-time.

At 816, the experience engine 106 detects an event that triggers a change to the configuration of the PDP. In such cases, the experience engine 106 alerts the configuration engine 102 to update the configuration file 103. Such changes may include changes to the user information, device information, variant information, and/or test information. In some examples, the configuration change corresponds to a change in the PDP issued by the website 122 (e.g., a layout change, format change, etc.). As such, the applier engine 108 may be instructed (e.g., by the configuration engine 102 or the experience engine 106) to update to the gallery structure 111. In some examples, the experience engine 106 is configured to relay user interactions with the PDP to the configuration engine 102 for the purpose of updating the configuration file 103 in real-time. In some examples, the asset engine 108 is configured to periodically query the content asset database 110 for an updated asset list 109. The applier engine 108 may compare the updated asset list 109 to the prior version to determine if assets have been added or replaced. If so, the applier engine 108 may automatically update the gallery structure 111.

As described above, improved systems and methods for generating dynamic PDPs are provided herein. In at least one embodiment, the system is configured to dynamically generate (or modify) a PDP of a website based on user information and device information. As such, the PDP can be tailored to provide the best possible experience for the user. In some examples, the system obtains user information that includes a navigation process experienced by the user in navigating to the PDP. In some examples, the system obtains device information associated with a user device being used to navigate to the PDP. In some examples, the system is configured to generate a user-specific gallery structure corresponding to a product based on the user information and the device information. In some examples, the system configures the PDP for the product using a user-specific content gallery generated from the gallery structure. In some examples, the system presents the PDP to the user via the website.

### Hardware and Software Implementations

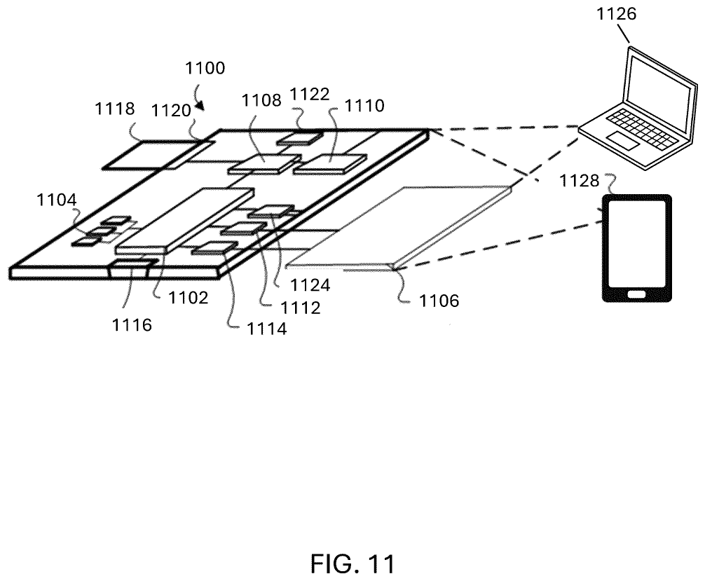

FIG. 11 shows an example of a generic computing device 1100, which may be used with some of the techniques described in this disclosure. Computing device 1100 includes a processor 1102, memory 1104, an input/output device such as a display 1106, a communication interface 1108, and a transceiver 1110, among other components. The device 1100 may also be provided with a storage device, such as a micro-drive or other device, to provide additional storage. Each of the components 1100, 1102, 1104, 1106, 1108, and 1110, are interconnected using various buses, and several of the components may be mounted on a common motherboard or in other manners as appropriate.

The processor 1102 can execute instructions within the computing device 1100, including instructions stored in the memory 1104. The processor 1102 may be implemented as a chipset of chips that include separate and multiple analog and digital processors. The processor 1102 may provide, for example, for coordination of the other components of the device 1100, such as control of user interfaces, applications run by device 1100, and wireless communication by device 1100.

Processor 1102 may communicate with a user through control interface 1112 and display interface 1114 coupled to a display 1106. The display 1106 may be, for example, a TFT LCD (Thin-Film-Transistor Liquid Crystal Display) or an OLED (Organic Light Emitting Diode) display, or other appropriate display technology. The display interface 1114 may comprise appropriate circuitry for driving the display 1106 to present graphical and other information to a user. The control interface 1112 may receive commands from a user and convert them for submission to the processor 1102. In addition, an external interface 1116 may be provided in communication with processor 1102, so as to enable near area communication of device 1100 with other devices. External interface 1116 may provide, for example, for wired communication in some implementations, or for wireless communication in other implementations, and multiple interfaces may also be used.

The memory 1104 stores information within the computing device 1100. The memory 1104 can be implemented as one or more of a computer-readable medium or media, a volatile memory unit or units, or a non-volatile memory unit or units. Expansion memory 1118 may also be provided and connected to device 1100 through expansion interface 1120, which may include, for example, a SIMM (Single In Line Memory Module) card interface. Such expansion memory 1118 may provide extra storage space for device 1100, or may also store applications or other information for device 1100. Specifically, expansion memory 1118 may include instructions to carry out or supplement the processes described above, and may include secure information also. Thus, for example, expansion memory 1118 may be provided as a security module for device 1100, and may be programmed with instructions that permit secure use of device 1100. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 1104, expansion memory 1118, memory on processor 1102, or a propagated signal that may be received, for example, over transceiver 1110 or external interface 1116.

Device 1100 may communicate wirelessly through communication interface 1108, which may include digital signal processing circuitry where necessary. Communication interface 1108 may in some cases be a cellular modem. Communication interface 1108 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1110. In addition, short-range communication may occur, such as using a Bluetooth, WiFi, or other such transceiver (not shown). In addition, GPS (Global Positioning System) receiver module 1122 may provide additional navigation-and location-related wireless data to device 1100, which may be used as appropriate by applications running on device 1100.

Device 1100 may also communicate audibly using audio codec 1124, which may receive spoken information from a user and convert it to usable digital information. Audio codec 1124 may likewise generate audible sound for a user, such as through a speaker, e.g., in a handset of device 1100. Such sound may include sound from voice telephone calls, may include recorded sound (e.g., voice messages, music files, etc.) and may also include sound generated by applications operating on device 1100. In some examples, the device 1100 includes a microphone to collect audio (e.g., speech) from a user. Likewise, the device 1100 may include an input to receive a connection from an external microphone.

The computing device 1100 may be implemented in a number of different forms, as shown in FIG. 11. For example, it may be implemented as a computer (e.g., laptop) 1126. It may also be implemented as part of a smartphone 1128, smart watch, tablet, personal digital assistant, or other similar mobile device.

Some implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for dynamically presenting a product detail page (PDP), comprising:
detecting a user has navigated to a PDP for a product on a first website;
obtaining user information associated with the user, wherein the user information includes a navigation process experienced by the user in navigating to the PDP;
obtaining device information associated with a user device used by the user to navigate to the PDP;
generating a user-specific gallery structure corresponding to the product based on the user information and the device information;
configuring the PDP using the user-specific gallery structure; and
presenting the PDP to the user via the first website.

2. The method of claim 1, wherein the user information includes at least one website Uniform Resource Locator (URL) associated with the user.

3. The method of claim 2, wherein the at least one website URL corresponds to at least one second website visited by the user prior to navigating to the first website.

4. The method of claim 2, wherein the at least one website URL corresponds to a second website that referred the user to the first website.

5. The method of claim 1, wherein the user information includes a search string associated with the user, a product campaign associated with the user, at least one behavioral characteristic of the user, an amount of time spent on the website by the user, an amount of time since the user last visited the website, or any combination thereof.

6. The method of claim 1, wherein the device information includes a location of the user device, an internet connection speed, a device type, or any combination thereof.

7. The method of claim 1, further comprising:
generating a configuration file based on the user information and the device information,
wherein generating the user-specific gallery structure corresponding to the product based on the user information and the device information includes generating the user-specific gallery structure based on the configuration file.

8. The method of claim 1, further comprising:
obtaining variant information associated with the PDP, wherein the variant information includes two or more variants of the PDP; and
generating a configuration file based on the user information, the device information, and the variant information,
wherein generating the user-specific gallery structure corresponding to the product based on the user information and the device information includes generating the user-specific gallery structure based on the configuration file.

9. The method of claim 1, further comprising:
obtaining test information associated with the PDP, wherein the test information includes two or more test groups that the user may be assigned to in relation to the PDP; and
generating a configuration file based on the user information, the device information, and the test information,
wherein generating the user-specific gallery structure corresponding to the product based on the user information and the device information includes generating the user-specific gallery structure based on the configuration file.

10. The method of claim 1, wherein generating the user-specific gallery structure corresponding to the product based on the user information and the device information includes:
analyzing the user information and the device information;
selecting a gallery structure template from a plurality of gallery structure templates corresponding to the product based on at least one result of the analysis; and
populating the gallery structure template with at least one content asset based on the user information and/or the device information.

11. The method of claim 1, wherein generating the user-specific gallery structure corresponding to the product based on the user information and the device information includes:
analyzing the user information and the device information;
selecting a predefined gallery structure from a plurality of predefined gallery structures corresponding to the product based on at least one result of the analysis; and
modifying at least one content asset of the predefined gallery structure based on the user information and/or the device information.

12. The method of claim 1, further comprising:
obtaining website information associated with prior user experiences with the website; and
modifying the user-specific gallery structure based on the website information.

13. The method of claim 12, wherein the website information includes an average time spent on the PDP by website visitors, an engagement rate with the PDP by website visitors, a purchase conversion rate associated with the product, an average order rate of the product, or any combination thereof.

14. The method of claim 1, further comprising:
generating a user-specific content gallery based on the user-specific gallery structure.

15. The method of claim 14, wherein the user-specific content gallery includes image content, non-interactive video content, interactive video content, or any combination thereof.

16. The method of claim 14, wherein configuring the PDP using the user-specific gallery structure includes selecting at least one content asset of the user-specific content gallery to be displayed on the PDP.

17. The method of claim 14, wherein configuring the PDP using the user-specific gallery structure includes:
analyzing the user information and the device information; and
determining an order in which content assets of the user-specific content gallery are presented on the PDP based on at least one result of the analysis.

18. The method of claim 14, further comprising:
detecting a change to the device information while the user is viewing the PDP; and
modifying the PDP in real-time based on the detected change.

19. The method of claim 18, wherein modifying the PDP includes selecting a different content asset of the user-specific content gallery to be displayed on the PDP.

20. A system for generating a dynamic product detail page (PDP), comprising:
at least one memory for storing computer-executable instructions; and
at least one processor for executing the instructions stored on the at least one memory, wherein execution of the instructions programs the at least one processor to perform operations comprising:
detecting a user has navigated to a PDP for a product on a first website;
obtaining user information associated with the user, wherein the user information includes a navigation process experienced by the user in navigating to the PDP;
obtaining device information associated with a user device used by the user to navigate to the PDP;
generating a user-specific gallery structure corresponding to the product based on the user information and the device information;
configuring the PDP using the user-specific gallery structure; and
presenting the PDP to the user via the first website.

21. The system of claim 20, wherein the user information includes at least one website Uniform Resource Locator (URL) associated with the user.

22. The system of claim 21, wherein the at least one website URL corresponds to at least one second website visited by the user prior to navigating to the first website.

23. The system of claim 21, wherein the at least one website URL corresponds to a second website that referred the user to the first website.

24. The system of claim 20, wherein the user information includes a search string associated with the user, a product campaign associated with the user, at least one behavioral characteristic of the user, an amount of time spent on the website by the user, an amount of time since the user last visited the website, or any combination thereof.

25. The system of claim 20, wherein the device information includes a location of the user device, an internet connection speed, a device type, or any combination thereof.

26. The system of claim 20, wherein the operations further comprise:
generating a configuration file based on the user information and the device information,
wherein generating the user-specific gallery structure corresponding to the product based on the user information and the device information includes generating the user-specific gallery structure based on the configuration file.

27. The system of claim 20, wherein the operations further comprise:
obtaining variant information associated with the PDP, wherein the variant information includes two or more variants of the PDP; and
generating a configuration file based on the user information, the device information, and the variant information,
wherein generating the user-specific gallery structure corresponding to the product based on the user information and the device information includes generating the user-specific gallery structure based on the configuration file.

28. The system of claim 20, wherein the operations further comprise:
obtaining test information associated with the PDP, wherein the test information includes two or more test groups that the user may be assigned to in relation to the PDP; and
generating a configuration file based on the user information, the device information, and the test information,
wherein generating the user-specific gallery structure corresponding to the product based on the user information and the device information includes generating the user-specific gallery structure based on the configuration file.

29. The system of claim 20, wherein generating the user-specific gallery structure corresponding to the product based on the user information and the device information includes:
analyzing the user information and the device information;
selecting a gallery structure template from a plurality of gallery structure templates corresponding to the product based on at least one result of the analysis; and
populating the gallery structure template with at least one content asset based on the user information and/or the device information.

30. The system of claim 20, wherein generating the user-specific gallery structure corresponding to the product based on the user information and the device information includes:
analyzing the user information and the device information;
selecting a predefined gallery structure from a plurality of predefined gallery structures corresponding to the product based on at least one result of the analysis; and
modifying at least one content asset of the predefined gallery structure based on the user information and/or the device information.

31. The system of claim 20, wherein the operations further comprise:
obtaining website information associated with prior user experiences with the website; and
modifying the user-specific gallery structure based on the website information.

32. The system of claim 31, wherein the website information includes an average time spent on the PDP by website visitors, an engagement rate with the PDP by website visitors, a purchase conversion rate associated with the product, an average order rate of the product, or any combination thereof.

33. The system of claim 20, wherein the operations further comprise:
generating a user-specific content gallery based on the user-specific gallery structure.

34. The method of claim 33, wherein the user-specific content gallery includes image content, non-interactive video content, interactive video content, or any combination thereof.

35. The system of claim 33, wherein configuring the PDP using the user-specific gallery structure includes selecting at least one content asset of the user-specific content gallery to be displayed on the PDP.

36. The system of claim 33, wherein configuring the PDP using the user-specific content gallery includes:
analyzing the user information and the device information; and
determining an order in which content assets of the user-specific content gallery are presented on the PDP based on at least one result of the analysis.

37. The system of claim 33, wherein the operations further comprise:
detecting a change to the device information while the user is viewing the PDP; and
modifying the PDP in real-time based on the detected change.

38. The system of claim 37, wherein modifying the PDP includes selecting a different content asset of the user-specific content gallery to be displayed on the PDP.
